(19) United States
(12) Patent Application Publication
(10) Pub. No.: US 2010/0044071 A1
(43) Pub. Date: Feb. 25, 2010

(54) Flat cable

(75) Inventors: Satoshi Murao, Yokkaichi-shi (JP); Nobuhiro Morimoto, Yokkaichi-shi (JP)

Correspondence Address: OLIFF & BERRIDGE, PLC, P.O. BOX 320850, ALEXANDRIA, VA, 22320-4850, US

(73) Assignees: AUTONETWORKS TECHNOLOGIES, LTD, Yokkaichi-shi (JP); SUMITOMO WIRING SYSTEMS, LTD, Yokkaichi-shi (JP); SUMITOMO ELECTRIC INDUSTRIES, LTD, Osaka-shi (JP)

(21) Appl. No.: 12/085,897

(22) PCT Filed: Nov. 9, 2007
(86) PCT No.: PCT/JP2007/071799

§ 371 Date: Jun. 5, 2009

(30) Foreign Application Priority Data
Nov. 9, 2006 (JP) 2006-304319

(51) Int. Cl. H01B 7/08

(52) U.S. Cl. 174/116

(57) ABSTRACT

A flat cable which is excellent in resistance to sliding and bending. A flat cable includes a plurality of conductors which are arranged in parallel apart from each other, and an insulation having a flexural modulus of no less than 200 MPa and less than 800 MPa, with which the conductors are extrusion-coated. It is preferable that the flexural modulus of the insulation is no less than 250 MPa and no more than 450 MPa. In addition, it is preferable that the insulation contains one or more than one kind of high polymer.

### TECHNICAL FIELD

The present invention relates to a flat cable, and more specifically relates to a flat cable which is suitably used in a repetitively sliding member such as an automotive sliding door and a printing section of a printer.

### BACKGROUND ART

Conventionally, a flat cable is used for wires used in electrical equipment incorporated into a vehicle such as an automobile, office automation equipment, a household electrical appliance, and other equipment for the purpose of saving space and weight. The flat cable is a cable which is entirely flat and excellent in flexibility, and has an advantage that a wiring direction thereof is freely changeable by being bent.

There is known a flat cable of a laminate type which is prepared by interposing a plurality of conductors arranged in parallel apart from each other between insulating resin films. The insulating resin films which are made from polyethylene terephthalate (PET) or other material are bonded together via adhesive layers made from a thermoplastic resin or other material by thermocompression bonding with the use of heating rolls.

However, there is a problem that in a production line on which the above-described flat cable of a laminate type is manufactured by bonding the laminated constituent elements by thermocompression bonding with the use of heating rolls after the materials are supplied, the line speed of the production line cannot be increased very much in order to make the flat cable acquire sufficient bonding force between the laminated constituent elements, which accordingly causes a decrease in productivity and an increase in production cost.

In addition, there is known a flat cable which is manufactured in a method of extrusion-coating a plurality of conductors arranged in parallel with an insulating resin. For example, a flat cable is disclosed in Japanese patent No. 3700861 which includes a plurality of conductors embedded in parallel in an extruded coating layer made from a thermoplastic resin with a flexural modulus of 800 MPa to 2400 MPa.

### DISCLOSURE OF THE INVENTION

### Problems to be Solved by the Invention

However, if a resin with which coating is made has a large flexural modulus like the resin in the flat cable disclosed in Japanese patent No. 3700861, the resin is stiff and not flexible. Consequently, a flat cable made from the resin with a large flexural modulus has a problem that if the flat cable develops a bending tendency at a bent portion at the time of sliding and bending, a crack could easily occur at the bent portion. Meanwhile, if a flat cable is made from a resin having an extremely small flexural modulus, the flat cable is too soft, and accordingly tends to buckle at a bent portion at the time of sliding and bending. Thus, there is apprehension that a break could easily occur at the bent portion.

The present invention has been made in view of the problems described above, and an object of the present invention is to overcome the problems and to provide a flat cable which is excellent in resistance to sliding and bending.

### Means to Solve the Problem

To achieve the objects and in accordance with the purpose of the present invention, a flat cable according to a preferred embodiment of the present invention includes a plurality of conductors which are arranged in parallel apart from each other, and an insulation having a flexural modulus of no less than 200 MPa and less than 800 MPa, with which the conductors are extrusion-coated.

In this case, it is preferable that the flexural modulus of the insulation is no less than 250 MPa and no more than 450 MPa.

In addition, it is preferable that the insulation contains one or more than one kind of high polymer.

### Effects of the Invention

Including the insulation having a flexural modulus of no less than 200 MPa and less than 800 MPa with which the conductors are extrusion-coated, the flat cable according to the preferred embodiment of the present invention has hardness as adequate as not to easily buckle at a bent portion at the time of sliding and bending. In addition, the flat cable has flexibility as adequate as not to easily develop a bending tendency at the time of sliding and bending, so that a crack hardly occurs. Therefore, the flat cable is excellent in resistance to sliding and bending.

If the flexural modulus of the insulation is no less than 250 MPa and no more than 450 MPa, the flat cable is highly excellent in resistance to sliding and bending.

In addition, if the insulation contains one or more than one kind of high polymer, the flexural modulus of the insulation is easy to adjust, which allows the range of material design to be extended.

### BRIEF DESCRIPTION OF THE DRAWINGS

FIG. 1 is a sectional view of a flat cable according to a preferred embodiment of the present invention;

FIG. 2 is a view showing a production line for a flat cable 10; and

FIG. 3 is a sectional view of an extruder 26.

### BEST MODE FOR CARRYING OUT THE INVENTION

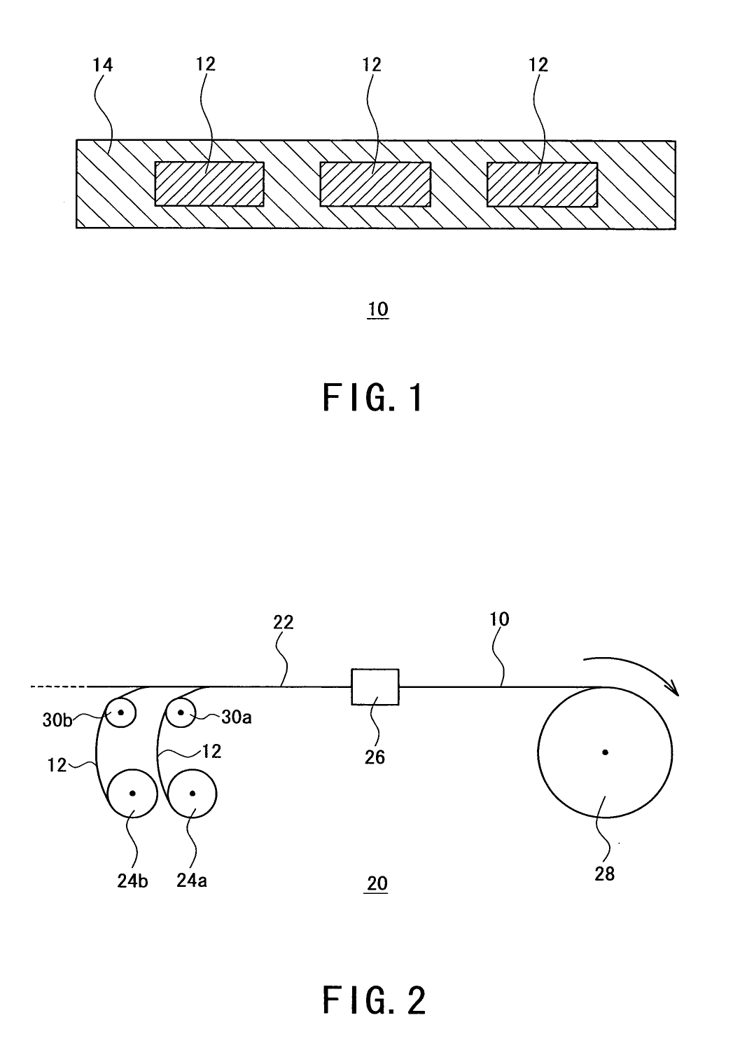

A detailed description of a preferred embodiment of the present invention will now be provided. FIG. 1 is a sectional view of a flat cable according to the preferred embodiment of the present invention.

As shown in FIG. 1, a flat cable 10 includes a plurality of rectangular conductors 12 which are arranged in parallel apart from each other, and an insulation 14 with which the conductors 12 are extrusion-coated.

The rectangular conductors 12 are preferably made from a copper material such as oxygen free copper, tough pitch copper and phosphor bronze. The copper material may be a soft copper material or a hard copper material. The copper material may be plated with metal such as tin and nickel. The thickness of each of the rectangular conductors 12 is not specifically limited, and is preferably 0.02 mm to 0.5 mm, and more preferably 0.03 mm to 0.2 mm. If the thickness of the rectangular conductors 12 decreases, the extrusion-coating becomes difficult to make. Meanwhile, if the thickness increases, sliding and bending characteristics of the flat cable are diminished. The width of each of the rectangular conductors 12 is determined appropriately as usage.

The insulation 14 is preferably made from a material having a flexural modulus of no less than 200 MPa and less than 800 MPa. This is because if the material has a flexural modulus of less than 200 MPa, the material is too soft and a flat cable made from the material tends to buckle at a bent portion at the time of sliding and bending. Hence, a break could easily occur at the bent portion. Meanwhile, if the material has a flexural modulus of no less than 800 MPa, the material is stiff and accordingly a flat cable made from the material is inferior in flexibility. Hence, if the flat cable 10 develops a bending tendency at a bent portion at the time of sliding and bending, a crack could easily occur at the bent portion.

If the material has a flexural modulus within the above-described range, the flat cable 10 is excellent in resistance to sliding and bending. Especially at the time of sliding and bending, the flat cable 10 exhibits excellent resistance to sliding and bending. It is preferable that the material has a flexural modulus of no less than 250 MPa and no more than 450 MPa. This is because if the material has a flexural modulus within this range, the flat cable 10 is highly excellent in resistance to sliding and bending.

It is to be noted that in the preferred embodiment of the present invention, “sliding and bending” defines repetitively making a motion of a flat cable with one end thereof reciprocated with a constant reciprocating stroke at a constant reciprocation speed while the flat cable is bent so as to have a given bending radius. For example, a flat cable which slides and bends is a flat cable which is used in a repetitively sliding member such as an automotive sliding door and a printing section of a printer.

In addition, a “flexural modulus” defines a value obtained by a measuring method specified in ASTM D790 (a value at a temperature of 23° C.)

It is essential only that the material for the insulation 14 be a material with which the conductors 12 can be extrusion-coated. The material may be a high polymer such as a resin and a rubber, and is not specifically limited. The resin or the rubber may be used by one kind alone or more than one kind in combination. The resin and the rubber may be used in combination.

The insulation 14 may be thus made from the material made up of two or more than two kinds of high polymers. Accordingly, if the insulation 14 is made from the material made up of two or more than two kinds of high polymers, it is essential only that the high polymers in a mixed state have a flexural modulus of no less than 200 MPa and less than 800 MPa. That is, one of the high polymers may have a flexural modulus beyond the range of the flexural modulus. If the insulation 14 is made from the material made up of a single kind of high polymer, it is essential only that the high polymer have a flexural modulus within the range of the flexural modulus.

Because the insulation 14 may be made from the material made up of not only a single kind of high polymer but also two or more than two kinds of high polymers, the flexural modulus of the insulation 14 is easy to adjust, which allows the range of material design to be extended.

The resin from which the insulation 14 is made may be a synthetic resin or a natural resin. Preferably used is a thermoplastic resin, examples of which include an olefin resin such as polypropylene (PP), polyethylene (PE), ethylene-methyl acrylate (EMA), ethylene-ethyl acrylate (EEA), ethylene-butyl acrylate (EBA), ethylene-methyl methacrylate (EMMA) and ethylene-vinyl acetate (EVA), an engineering plastic such as a polyamide resin (PA), a polyester resin such as polyethylene terephthalate (PET) and polybutylene terephthalate (PBT) a polysulfone resin, a polyarylate resin, a polyphenylene sulfide (PPS) resin, a polyphenylene ether (PPE) resin and a polycarbonate (PC), a thermoplastic polyurethane resin, and a thermoplastic elastomer such as an olefin elastomer (TPO), a styrene elastomer (SEBS), an amide elastomer, an ester elastomer, a urethane elastomer, an ionomer, a fluorinated elastomer, 1,2-polybutadiene and trans-1,4-polyisoprene.

The rubber from which the insulation 14 is made is preferably an ethylene-propylene rubber (EPR), a butadiene rubber (BR) or an isoprene rubber (IR).

The resin and the rubber may be introduced (modified) by a functional group in order to improve various physical properties, examples of which include a carboxyl group, an acid anhydride group, an epoxy group, a hydroxyl group, an amino group, an alkenyl cyclic imino ether group and a silane group, which are all well-known.

A filler such as a flame retardant can be added to the resin and the rubber as necessary. The examples of the filler include metal powder, carbon black, graphite, carbon fiber, silica, almina, titanium oxide, iron oxide, zinc oxide, magnesium oxide, tin oxide, antimony oxide, barium ferrite, strontium ferrite, aluminum hydroxide, magnesium hydroxide, calcium sulfate, magnesium sulfate, barium sulfate, talc, clay, mica, calcium silicate, calcium carbonate, magnesium carbonate, glass fiber, calcium titanate, lead zirconate titanate, aluminum nitride, silicon carbide, wood fiber, fullerene, carbon nanotube, and melamine cyanurate. The filler may be used by one kind alone or more than one kind in combination.

In addition to the high polymer and the filler, an additive which is usually added to a molding material may be compounded with the material for the insulation 14 insofar as physical properties of the material are not impaired. Examples of the additive include an antioxidant, a metal deactivator (e.g., a copper inhibitor), an ultraviolet absorber, an ultraviolet-concealing agent, a processing aid (e.g., a lubricant, wax), and a coloring agent.

The coating thickness of the high-polymer material with which the conductors 12 are extrusion-coated is not specifically limited, and is preferably from 0.02 mm to 0.5 mm measured from surfaces of the conductors 12. If the coating thickness is less than 0.02 mm, the reliability of the insulation 14 tends to decrease because of the thin thickness. Meanwhile, if the coating thickness is more than 0.5 mm, sliding and bending characteristics of the flat cable 10 tend to be diminished because of the thick thickness.

Next, a description of one example of a method for manufacturing the flat cable 10 will be provided. The manufacturing method is practiced with the use of a continuous production line, and the flat cable 10 is manufactured in an extrusion-coating method.

FIG. 2 is a view showing the production line for the flat cable 10. As shown in FIG. 2, a production line 20 has a configuration such that a plurality of conductor supply rolls 24a, 24b . . . each of which defines a member for supplying the linear rectangular conductor 12 which is wound and housed therein are disposed in an upstream position of a transfer route 22, an extruder 26 is disposed in a midstream position of the transfer route 22, and a wind-up roll 28 for winding up the manufactured flat cable 10 is disposed in a downstream position of the transfer route 22. The supply rolls 24a, 24b . . . are provided respectively with guide rolls 30a, 30b . . . for guiding the rectangular conductors 12 to the transfer route 22.

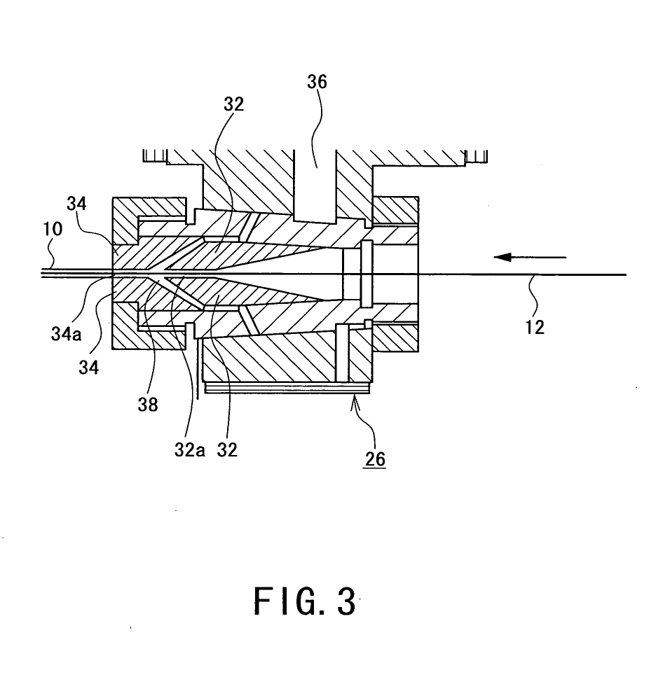

FIG. 3 is a sectional view of the extruder 26. The extruder 26 has a configuration such that a nipple 32 and a die 34 are disposed inside a main body of the extruder 26, a supply port 36 for supplying a high-polymer material such as a thermoplastic resin is disposed in an upper section of the extruder 26. The supply port 36 communicates with a space 38 between the nipple 32 and the die 34.

The rectangular conductors 12 are supplied from the supply rolls 24a, 24b . . . , are transferred on the transfer route 22 while being arranged in parallel apart from each other, and are supplied into the extruder 26. The rectangular conductors 12 supplied into the extruder 26 are arranged in parallel through nipple holes 32a which are provided with guides for arranging the rectangular conductors 12 in parallel at given intervals, and are transferred to the space 38 between the nipple 32 and the die 34. At this time, a high-polymer material such as a thermoplastic resin is supplied in a molten state from the supply port 36 into the space 38, with which the plurality of rectangular conductors 12 arranged in parallel are coated. Then, the flat cable 10 is manufactured after passing through a die hole 34a. The flat cable 10 is wound up by the wind-up roll 28.

### EXAMPLE

A description of the present invention will now be provided specifically with reference to Examples; however, the present invention is not limited hereto.

Test Material

Test materials used in Examples are given along with manufacturers and trade names.

(A) Resin

Modified polyphenylene ether (PPE) [manuf.: GE Plastics Japan Ltd., trade name: “Noryl”]

Hydrogenated styrene thermoplastic elastomer [Asahi Kasei Chemicals Corporation, trade name: “Tuftec”]

Polypropylene (PP) [manuf.: Japan Polypropylene Corporation, trade name: “NOVATEC” (extrusion molding grade)]

Hydrogenated styrene thermoplastic elastomer (a modified type) [Asahi Kasei Chemicals Corporation, trade name: “Tuftec”]

Thermoplastic polyurethane elastomer [BASF Japan Ltd., trade name: “Elastollan”]

Polyarylate [Unitika Ltd., trade name: “U-polymer”]

Polyetherimide [manuf.: GE Plastics Japan Ltd., trade name: “Ultem”]

Polyvinyl chloride (PVC) [manuf.: Shin Dai-ichi Vinyl Corporation, trade name: “ZEST”]

(B) Filler

Magnesium hydroxide [manuf.: Kyowa Chemical Industry Co., Ltd., trade name: “KISUMA”]

Melamine cyanurate [manuf.: Nissan Chemical Industries, Ltd., trade name: “Melamine cyanurate”]

Measurement of a Flexural Modulus

Measurement of a flexural modulus is performed in accordance with ASTM D790. To be specific, a flexural modulus of each of strip test specimens (127 mm×12.7 mm×3.2 mm) made from high-polymer materials of composition shown in Table 1, on which, a load is imposed at its center portion with both the ends fixed, is calculated from the amount each test specimen is bent and the load imposed on each test specimen.

Bending Test

A bending test is performed in accordance with JIS C5016. To be specific, the bending test is performed by subjecting one end of a test specimen, which is prepared by cutting up a flat cable manufactured in the undermentioned manner into a length of 300 mm and shaping it into a letter U so as to have a bending radius R of 15 mm, to sliding and bending motion such that the subjected end reciprocates with a reciprocating stroke of 50 mm at a reciprocating speed of 1000 strokes per minute while the other end of the test specimen is fixed. A test assessment is made by counting the number of the strokes of the test specimen before an electrical break occurs in its rectangular conductor, and the test specimen of which the number of strokes is 100,000 times or more is regarded as passed.

### Examples 1 to 4

Flat cables of which insulations are made from high-polymer materials of composition according to Examples 1 to 4 shown in Table 1 were each manufactured by extrusion-coating two conductors arranged in parallel each having a cross-sectional area of 0.15 mm×1.5 mm with the high-polymer material having a thickness of 0.1 mm. Flexural moduli of the high-polymer materials with which the conductors are to be extrusion-coated were measured, and bending tests were performed on the manufactured flat cables. The results are given in Table 1.

### Comparative Examples 1 to 5

In the same manner as the flat cables according to Examples 1 to 4, flat cables of which insulations are made from high-polymer materials of composition according to Comparative Examples 1 to 5 shown in Table 1 were each manufactured by extrusion-coating wires with the high-polymer material. Flexural moduli of the high-polymer materials with which the conductors are to be extrusion-coated were measured, and bending tests were performed on the manufactured flat cables. The results are given in Table 1.

TABLE 1

| | | Example | | | | Comparative Example | | | | |
|---|---|---|---|---|---|---|---|---|---|---|
| | | 1 | 2 | 3 | 4 | 1 | 2 | 3 | 4 | 5 |
| Composition of | Modified polyphenylene ether | 80 | | | | | 100 | | | |
| high-polymer | Hydrogenated styrene | 20 | | | | | | | | |
| material to | thermoplastic elastomer | | | | | | | | | |
| be coated | Polypropylene | | 70 | 70 | 60 | | | | | |
| | Hydrogenated styrene | | 30 | 30 | 40 | | | | | |
| | thermoplastic elastomer | | | | | | | | | |
| | (modified type) | | | | | | | | | |
| | Thermoplastic polyurethane | | | | | 100 | | | | |
| | elastomer | | | | | | | | | |
| | Polyarylate | | | | | | | 100 | | |
| | Polyether imide | | | | | | | | 100 | |
| | PVC | | | | | | | | | 100 |
| | Magnesium hydroxide | | 120 | 140 | 180 | | | | | |
| | Melamine cyanurate | | | | | 20 | | | | |
| | Flexural modulus (Mpa) | 280 | 390 | 420 | 710 | 30 | 1130 | 2100 | 2970 | 120 |
| | the number of strokes | 940000 | 520000 | 500000 | 150000 | 95000 | 90000 | 60000 | 70000 | <100000 |

According to Table 1, it is shown that the flat cables according to Examples 1 to 4 each gave a result that the number of strokes was far more than 100,000 times, from which it is apparent that the flat cables according to Examples 1 to 4 are each excellent in resistance to sliding and bending. The reason of this is considered that the flexural moduli of the high-polymer materials which make up insulations of the flat cables each fall within a range of no less than 200 MPa and less than 800 MPa. Among the flat cables according to Examples 1 to 4, the flat cables according to Examples 1 to 3 which include the insulations made up of the high-polymer materials having the flexural moduli within a range of no less than 250 MPa and no more than 450 MPa are especially excellent in resistance to sliding and bending.

Meanwhile, it is shown that the flat cables according to Comparative Examples 1 and 5 each buckled at a bent portion at the time of sliding and bending in the bending test before the number of strokes reaches 100,000 times that defines a criterion for passing the bending test. The reason of this is considered that the flexural moduli of the high-polymer materials which make up insulations of the flat cables each fall below 200 MPa and rigidity of each of the insulations is low.

In addition, it is shown that in each of the flat cables according to Comparative Examples 2 to 4, a fatigue break occurred at a bent portion at the time of sliding and bending in the bending test before the number of strokes reaches 100,000 times that defines the criterion for passing the bending test. The reason of this is considered that the flexural moduli of the high-polymer materials which make up the insulations of the flat cables each go beyond 800 MPa and each of the insulations is too stiff and is inferior in flexibility.

These results show that the flat cables according to Examples 1 to 4 are each capable of acquiring sufficient resistance to sliding and bending even when wired in a position where the cables are subjected to sliding and bending, and therefore can be suitably used in a repetitively sliding member such as an automotive sliding door and a printing section of a printer.

The foregoing description of the preferred embodiment and the implementation example of the present invention has been presented for purposes of illustration and description. However, it is not intended to limit the present invention to the preferred embodiment, and modifications and variations are possible as long as they do not deviate from the principles of the present invention.

For example, while used for the conductors in the above-described preferred embodiment of the present invention is a rectangular conductor, a conductor having the shape different from a rectangle such as a conductor of circular cross section may be used instead.

1. A flat cable comprising:
a plurality of conductors which are arranged in parallel apart from each other; and
an insulation having a flexural modulus of no less than 200 MPa and less than 800 MPa, with which the conductors are extrusion-coated.

2. The flat cable according to claim 1, wherein the flexural modulus of the insulation is no less than 250 MPa and no more than 450 MPa.

3. The flat cable according to claim 1, wherein the insulation contains one or more than one kind of high polymer.

4. The flat cable according to claim 2, wherein the insulation contains one or more than one kind of high polymer.
